(19) United States
(12) Patent Application Publication
(10) Pub. No.: US 2005/0123008 A1
(43) Pub. Date: Jun. 9, 2005

(54) Multiple input/output ECDL cavity length and filter temperature control

(76) Inventors: Andrew J. Daiber, Ernerald Hills, CA (US); Mark S. Rice, San Jose, CA (US); Rajesh K. Batra, Palo Alto, CA (US); Ken P. Koller, San Francisco, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/731,172

(22) Filed: Dec. 8, 2003

(51) Int. Cl. H01S 3/10

(52) U.S. Cl. 372/20; 372/92

(57) ABSTRACT

A servo or control technique and apparatus for an external cavity diode laser (ECDL) are described. Coarse tuning adjustments for the ECDL may be performed by varying the temperature of tunable filters. Fine tuning adjustments may be performed varying the temperature of the ECDL sled (base) to vary the length of the cavity via thermal contraction and expansion. A controller comprises a coupler matrix that mathematically relates multiple control signal inputs for varying the temperatures of the tunable filters and sled to produce multiple outputs used to control, for example, thermal-electric cooler (TEC) elements associated with the tunable filters and sled.

### FIELD OF THE INVENTION

Embodiments of the present invention relate to lasers and, more particularly, to tunable lasers.

### BACKGROUND INFORMATION

Wavelength division multiplexing (WDM) is a technique used to transmit multiple channels of data simultaneously over the same optic fiber. At a transmitter end, different data channels are modulated using light having different wavelengths (colors) for each channel. The fiber can simultaneously carry multiple channels in this manner. At a receiving end, these multiplexed channels may be easily separated prior to demodulation using appropriate wavelength filtering techniques.

The need to transmit greater amounts of data over a fiber has led to so-called Dense Wavelength Division Multiplexing (DWDM). DWDM involves packing additional channels into a given bandwidth space. The resultant narrower spacing between adjacent channels in DWDM systems demands precision wavelength accuracy from the transmitting laser diodes.

Tunable lasers offer a flexible and cost-effective option for use in optical networking applications. A single tunable laser may replace anyone of hundreds of fixed wavelength lasers in a DWDM link and therefore offer a significant opportunity for cost reduction. They further allow precise control over the wavelength separation between lasers in the array. The ability to tune the lasing frequency also relaxes fabrication tolerances and makes for robust laser components that may be tuned to compensate for ambient temperature changes and drift due to the effects of aging. Tunable lasers further offer the advantage of permitting flexible network management as well as lending themselves well to reconfiguration. This lends to a more efficient bandwidth usage that can be readily adaptable to new customer services.

There is an increasing demand for tunable lasers for test and measurement uses, wavelength characterization of optical components, fiber optic networks and other applications. In dense wavelength division multiplexing (DWDM) fiber optic systems, multiple separate data streams propagate concurrently in a single optical fiber, with each data stream created by the modulated output of a laser at a specific channel frequency or wavelength. Presently, channel separations of approximately 0.4 nanometers in wavelength, or about 50 GHz are achievable, which allows up to 128 channels to be carried by a single fiber within the bandwidth range of currently available fibers and fiber amplifiers. Greater bandwidth requirements will likely result in smaller channel separation in the future.

DWDM systems have largely been based on distributed feedback (DFB) lasers operating with a reference etalon associated in a feedback control loop, with the reference etalon defining the International Telecommunication Union (ITU) wavelength grid. Statistical variation associated with the manufacture of individual DFB lasers results in a distribution of channel center wavelengths across the wavelength grid, and thus individual DFB transmitters are usable only for a single channel or a small number of adjacent channels.

Continuously tunable external cavity lasers have been developed to overcome the limitations of individual DFB devices. Various laser-tuning mechanisms have been developed to provide external cavity wavelength selection, such as mechanically tuned gratings used in transmission and reflection. External cavity lasers should be able to provide a stable, single mode output at selectable wavelengths while effectively suppress lasing associated with external cavity modes that are within the gain bandwidth of the cavity. These goals have been difficult to achieve, and there is accordingly a need for an external cavity laser that provides stable, single mode operation at selectable wavelengths.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 is a schematic diagram of a generalized embodiment of an external cavity diode laser (ECDL);

FIG. 2 is a diagram illustrating the effect modulating the optical path length of an ECDL laser cavity has on the frequency of the lasing mode and the modulation of the laser's output intensity;

FIG. 3 is a diagram illustrating how a modulated excitation input signal and a resulting response output signal can be combined to calculate a demodulated error signal;

FIG. 4 is a schematic diagram of an ECDL in accordance with an embodiment of the invention in which a Lithium Niobate block is employed as an optical path length adjustment element;

FIG. 5 is a block diagram illustrating a control scheme for controlling the temperatures of the various tunable elements;

FIG. 6 is a block diagram of a control scheme employing a coupler matrix for mathematically manipulating multiple inputs to produce multiple outputs for locking filter temperature to cavity length; and

FIGS. 7A-7C include exemplary coupler matrices for relating an input signal matrix to an output signal matrix for achieving a desired tuning operation.

### DETAILED DESCRIPTION

Embodiments of a servo or control technique and apparatus for performing wavelength locking that locks the cavity length of an external cavity diode laser (ECDL) to other tunable elements such as temperature controlled filters are disclosed. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As an overview, a generalized embodiment of an ECDL 100 that may be used to implement aspects of the invention described below is shown in FIG. 1. ECDL 100 includes a gain medium comprising a diode gain chip 102. Diode gain chip 102 comprises a Fabry-Perot diode laser including a partially-reflective front facet 104 and a substantially non-reflective rear facet 106 coated with an anti-reflective (AR) coating to minimize reflections at its face. Optionally, diode gain chip 102 may comprise a bent-waveguide structure on the gain medium to realize the non-reflective rear facet 106. The external cavity elements include a diode intracavity collimating lens 108, tuning filter elements 110, a cavity-length modulating element 112, and a reflective element 114. In general, reflective element 114 may comprise a mirror, grating, prism, or other reflector or retroreflector which may also provide the tuning filter function in place of element 110. The output side components include a diode output collimating lens 116, an optical isolator 118, and a fiber focusing lens 120, which focuses an output optical beam 122 such that it is launched into an output fiber 124.

The basic operation of ECDL 100 is a follows. A controllable current I is supplied to diode gain chip 102 (the gain medium), resulting in a voltage differential across the diode junction, which produces an emission of optical energy (photons). The emitted photons pass back and forth between partially-reflective front facet 104 and reflective element 114, which collectively define the ends of the laser cavity. As the photons pass back and forth, a plurality of resonances, or “lasing” modes are produced. Under a lasing mode, a portion of the optical energy (photons) temporarily occupies the external laser cavity, as depicted by intracavity optical beam 126; at the same time, a portion of the photons in the external laser cavity eventually passes through partially-reflective front facet 104.

Light comprising the photons that exit the laser cavity through partially-reflective front facet 104 passes through diode output collimating lens 116, which collimates the light into output beam 122. The output beam then passes through optical isolator 118. The optical isolator is employed to prevent back-reflected light from being passed back into the external laser cavity, and is generally an optional element. After the light beam passes through the optical isolator, it is launched into the output fiber 124 by fiber focusing lens 120. Generally output fiber 124 may comprise a polarization-preserving type or a single-mode type such as SMF-28.

Through appropriate modulation of the input current (generally for communication rates of up to 2.5 GHz) or through modulation of an external element disposed in the optical path of the output beam (not shown) (for 10 GHz and 40 GHz communication rates), data can be modulated on the output beam to produce an optical data signal. Such a signal may launched into a fiber and transmitted over a fiber-based network in accordance with practices well known in the optical communication arts, thereby providing very high bandwidth communication capabilities.

The lasing mode of an ECDL is a function of the total optical path length between the cavity ends (the cavity optical path length); that is, the optical path length encountered as the light passes through the various optical elements and spaces between those elements and the cavity ends defined by partially-reflective front facet 104 and reflective element 114. This includes diode gain chip 102, diode intracavity collimating lens 108, tuning filter elements 110, and cavity-length modulating element 112, plus the path lengths between the optical elements (i.e., the path length of the transmission medium occupying the ECDL cavity, which is typically a gas such as air). More precisely, the total optical path length is the sum of the path lengths through each optical element and the transmission medium times the coefficient of refraction for that element or medium.

As discussed above, under a lasing mode, photons pass back and forth between the cavity end reflectors at a resonance frequency, which is a function of the cavity optical path length. In fact, without the tuning filter elements, the laser would resonate at multiple frequencies. For simplicity, if we model the external laser as a Fabry-Perot cavity, these frequencies can be determined from the following equation:

$$Cl = \frac{λ x}{2 n} \qquad ( 1 )$$

where λ=wavelength, Cl=Length of the cavity, x=an arbitrary integer—1, 2, 3, . . . , and n=refractive index of the medium. The number of resonant frequencies is determined from the width of the gain spectrum. Furthermore, the gain spectrum is generally shaped as a parabola with a central peak—thus, the intensity of the lasing modes on the sides of the center wavelength (commonly called the side modes) rapidly drops off.

As describe below in further detail, various techniques may be applied to “tune” the laser to produce an optical output signal at a frequency corresponding to a desired communication channel. For example, this may be accomplished by adjusting one or more tuning elements, such as tuning filter elements 110, to produce a corresponding change in the cavity optical path length, thus changing the lasing mode frequency. The tuning filter elements attenuate the unwanted lasing modes such that the output beam comprises substantially coherent light having a narrow bandwidth.

Ideally, it is desired to maximize the power of the output beam over a frequency range corresponding to the various channel frequencies the ECDL is designed for. While an obvious solution might be to simply provide more drive current, this, by itself, doesn't work because a change in the drive current changes the optical characteristics (e.g., optical path length) of the diode gain chip. Furthermore, many diode gain chips only operate over a limited range of input current.

In accordance with aspects of the invention, one technique for producing a maximal power output is to perform “wavelength locking” through phase control modulation. Under this technique, a “dither” or modulation signal is supplied to cause a corresponding modulation in the optical path length of the laser cavity. This produces a modulated phase-shift effect, resulting in a small frequency modulation of the lasing mode. The result of this frequency modulation produces a corresponding modulation of the intensity (power) of the output beam, also referred to as amplitude modulation. This amplitude modulation can be detected using various techniques. In one embodiment, the laser diode junction voltage (the voltage differential across laser diode chip 102) is monitored while supplying a constant current to the laser diode, wherein the voltage is inversely proportional to the intensity of the output beam, e.g., a minimum measured diode junction voltage corresponds to a maximum output intensity. In another embodiment, a beam splitter is employed to split off a portion of the output beam such that the intensity of the split-off portion can be measured by a photo-electric device, such as a photodiode. The intensity measured by the photodiode is proportional to the intensity of the output beam. The measured amplitude modulation may then be used to generate a demodulated error signal that is fed back into a servo control loop to adjust the (substantially) continuous optical path length of the laser so as to produce maximal intensity.

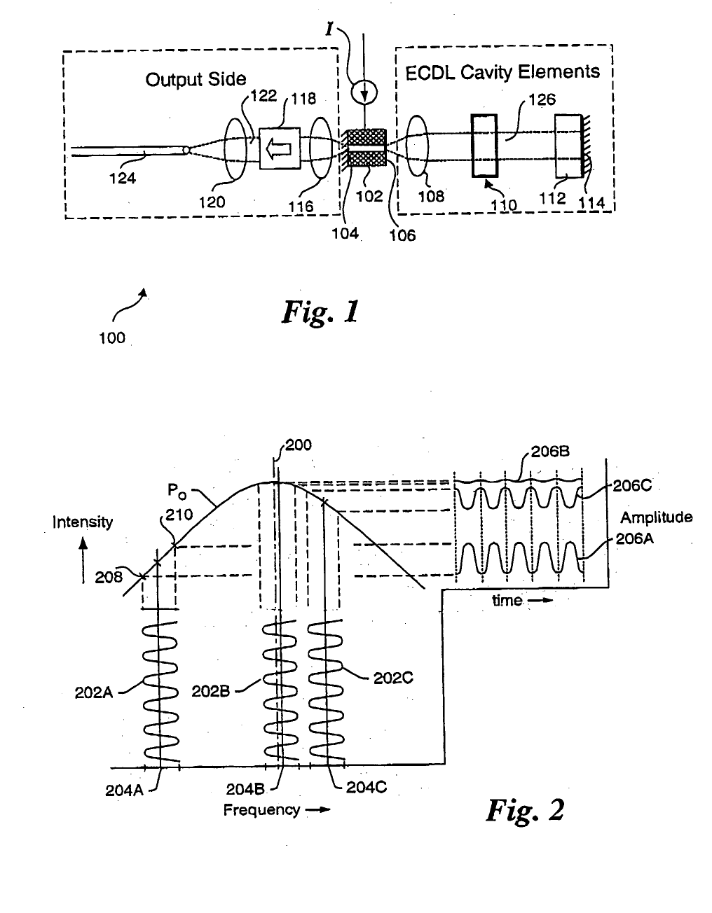

The foregoing scheme is schematically illustrated in FIG. 2. The diagram shows a power output curve (P_{O}) that is illustrative of a typical power output curve that results when the lasing mode is close to a desired channel, which is indicated by a channel frequency centerline 200. The objective of a servo loop that employs the phase-shift modulation scheme is to adjust one or more optical elements in the laser cavity such that lasing frequency is shifted toward the desired channel frequency. This is achieved through use of a demodulated error signal that results from frequency modulation of the lasing mode. Under the technique, a modulation signal is supplied to an optical element in the cavity, such as optical length modulation element 112, to modulate the optical path length of the cavity. This modulation is relatively small compared to the channel spacing for the laser. For example, in one embodiment the modulation may have an excursion of 4 MHz, while the channel spacing is 50 GHz.

Modulated signals 202A, 202B, and 202C respectively correspond to (average) laser frequencies 204A, 204B, and 204C. Laser frequency 204A is less than the desired channel frequency, laser frequency 204C is higher than the desired channel frequency, while 204B is near the desired channel frequency. Each modulated signal produces a respective modulation in the intensity of the output beam; these intensity modulations are respectively shown as modulated amplitude waveforms 206A, 206B, and 206C. Generally, the intensity modulations can be measured in the manners discussed above for determining the intensity of the output beam.

As depicted in FIG. 2, the peak to valley amplitude of waveforms 206A, 206B, and 206C is directly tied to the points in which the modulation limits for their corresponding frequency modulated signals 202A, 202B, and 202C intersect with power output curve P_{O}, such as depicted by intersection points 208 and 210 for modulated signal 202A. Thus, as the laser frequency gets closer to the desired channel frequency, the peak to valley amplitude of the measured intensity of the output beam decreases. At the point where the laser frequency and the channel frequency coincide, this value becomes minimized.

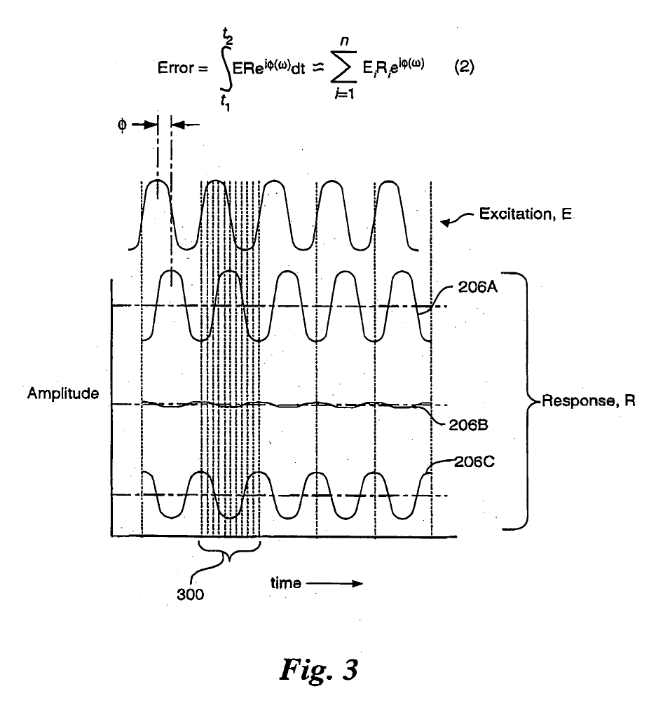

Furthermore, as shown in FIG. 3, the cavity length error may be derived from:

$$Error = {\int }_{{t}_{1}}^{{t}_{2}} ER {ⅇ}^{ⅈϕ ( ω )} ⅆ t \approx {\sum }_{i = 1}^{n} {E}_{i} {R}_{i} {ⅇ}^{ⅈϕ ( ω )} \qquad ( 2 )$$

wherein the non-italicized i is the imaginary number, φ represents the phase difference between the excitation input (i.e., modulated signals 202A, 202B, and 202C) and the response output comprising the amplitude modulated output waveforms 206A, 206B, and 206C, and ω is the frequency of modulation. The integral solution can be accurately approximated by a discreet time sampling scheme typical of digital servo loops of the type described below, as depicted by time sample marks 300.

In addition to providing an error amplitude, the foregoing scheme also provides an error direction. For example, when the laser frequency is in error on one side of the desired channel frequency (lower in the illustrated example), the excitation and response waveforms will be substantially in phase. This will produce a positive aggregated error value. In contrast, when the laser frequency is on the other side of the desired channel frequency (higher in the example), the excitation and response waveforms are substantially out of phase. As a result, the aggregated error value will be negative.

Generally, the wavelength locking frequency of modulation ω should be selected to be several orders of magnitude below the laser frequency. For example, modulation frequencies within the range of 500 Hz-100 kHz may be used in one embodiment with a laser frequency of 185-199 THz.

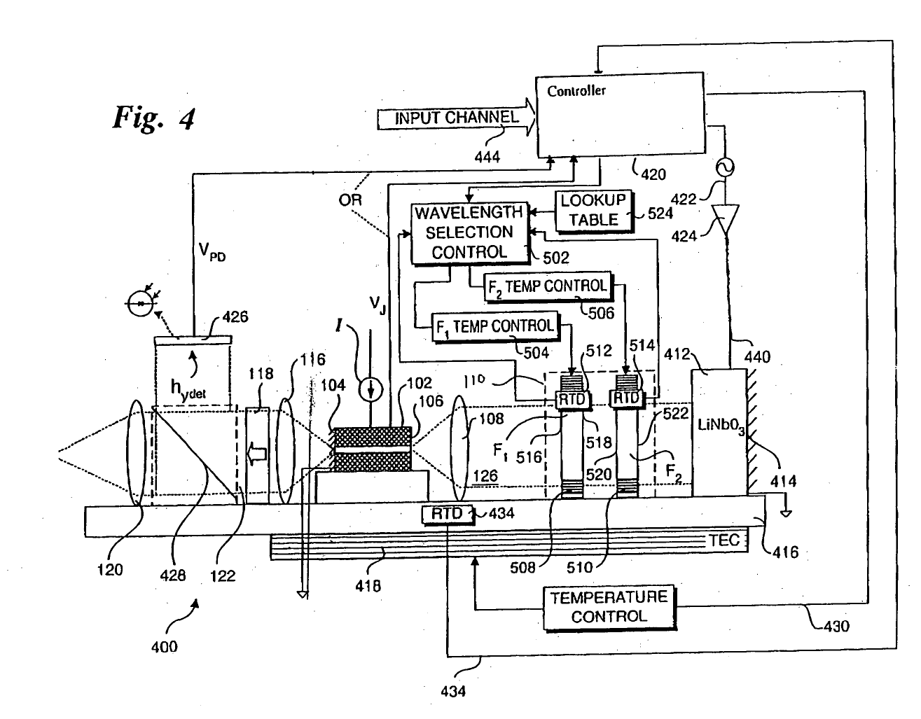

In FIG. 4, an ECDL 400 is shown including various elements common to ECDL 100 having like reference numbers, such as a gain diode chip 102, lenses 108,116, and 120, etc. A channel selection subsystem may include a wavelength selection control block 502. It is noted that although the wavelength selection control block is shown external to controller 420, the control aspects of this block may be provided by the controller 420 alone. Wavelength selection control block 502 provides electrical outputs 504 and 506 for controlling the temperatures of filters F1 and F2, respectively. In one embodiment, temperature control element is disposed around the perimeter of a circular etalon, as depicted by TECs 508 and 510. Heaters imbedded inside of the filters may also be used to control etalon temperature. Respective RTDs 512 and 514 are employed to provide a temperature feedback signal back to wavelength selection control block 502.

Generally, etalons are employed in laser cavities to provide filtering functions. They function as Fabry-Perot resonators. The result of passing an optical beam through an etalon produces a set of transmission peaks (also called passbands) in the laser output. The spacing of the transmission peaks (in frequency, also known as the free spectral range) is dependent on the distance between the two faces of the etalon, e.g., faces 516 and 518 for filter F1, and faces 520 and 522 for filter F2. As the temperatures of the etalons change, the etalon material is caused to expand or contract, thus causing the distance between the faces to change. This effectively changes the optical path length of the etalons, which may be employed to shift the transmission peaks.

The effect of the filters is cumulative. As a result, all lasing modes except for a selected channel lasing mode can be substantially attenuated by lining up a single transmission peak of each filter. In one embodiment, the configurations of the two etalons are selected such that the respective free spectral ranges of the etalons are slightly different. This enables transmission peaks to be aligned under a Vernier tuning technique similar to that employed by a Vernier scale. In one embodiment, one of the filters, known as a “grid generator,” is configured to have a free spectral range corresponding to a communications channel grid, such as the ITU wavelength grid, and the peaks are aligned with ITU channel frequencies. This wavelength grid remains substantially fixed by maintaining the temperature of the corresponding grid generator etalon at a predetermined temperature. At the same time, the temperature of the other etalon, known as the channel selector, is adjusted so as to shift its transmission peaks relative to those of the grid generator. By shifting the transmission peaks of the filters in this manner, transmission peaks corresponding to channel frequencies may be aligned, thereby producing a cavity lasing mode corresponding to the selected channel frequency. In another embodiment, the transmission peaks of both the filters are shifted to select a channel.

Generally, either of these schemes may be implemented by using a channel-etalon filter temperature lookup table in which etalon temperatures for corresponding channels are stored, as depicted by lookup table 524. Typically, the etalon temperature/channel values in the lookup table may be obtained through a calibration procedure, through statistical data, or calculated based on tuning functions or equations fit to the tuning data. In response to an input channel selection 444, the corresponding etalon temperatures are retrieved from lookup table 524 and employed as target temperatures for the etalons using appropriate temperature control loops, which are well-known in the art.

ECDL 400 may further include a cavity optical path length modulating element 412 having a reflective rear face 414. More specifically, the cavity optical path length modulating element comprises a Lithium Niobate (LiNbO3) phase modulator to which a back-side mirror is coupled. Optionally, a reflective material may be coated onto the backside of the phase modulator. Lithium Niobate is a material that changes its index of refraction (ratio of the speed of light through the material divided by the speed of light through a vacuum) when a voltage is applied across it. As a result, by providing a modulated voltage signal across the LiNbO3 phase modulator, the optical path length of the external laser cavity can be caused to modulate or “dithered”, thereby producing frequency modulated signals such as signals 202A, 202B, and 202C discussed above.

The various optical components of the ECDL 400 are mounted or otherwise coupled to a thermally-controllable base or “sled” 416. In one embodiment, one or more thermal-electric cooler (TEC) elements 418, such as a Peltier element, are mounted on or integrated in sled 416 such that the temperature of the sled can be precisely controlled via an input electrical signal. Due to the expansion and contraction of a material in response to a temperature change, the length of the sled can be adjusted very precisely. Adjustment of the length results in a change in the distance between partially reflective front facet 104 and reflective element 414, which produces a change in the optical path length of the laser cavity. As a result, controlling the temperature of the sled can be used to adjust the frequency of the lasing mode. In general, temperature control of the sled will be used for very fine tuning adjustments, while coarser tuning adjustments will be made by means of tuning filter elements 110, as described in further detail below.

For wavelength-locking, a controller 420 generates a modulated or “dithered” wavelength-locking signal 422, which is amplified by an amplifier 424. For example, in one embodiment modulated wavelength locking signal 422 may comprise a sinewave having a constant frequency, such as a 2-volt peak-to-peak signal with a frequency of about 889 Hz. The amplified modulated wavelength locking signal is then supplied to a surface of the LiNbO3 phase modulator 412, while an opposite surface is connected to ground, thereby providing a voltage differential across the LiNbO3 material. As a result, the optical path length of the modulator, and thus the entire laser cavity, is modulated at the modulation frequency (e.g. 889 Hz). In one embodiment, the 2-volt peak-to-peak voltage differential results in a frequency excursion of approximately 4 MHz.

This path length modulation produces a modulation in the intensity of output beam 122, which in one embodiment is detected by a photodetector 426. As depicted in FIG. 4, a beam splitter 428 is disposed in the optical path of output beam 122, causing a portion of the output beam light to be directed toward photodetector 426. In one embodiment, photodetector 426 comprises a photo diode, which generates a voltage charge in response to the light intensity it receives (hvdet). A corresponding voltage V_{PD} is then fed back to controller 420. In an optional embodiment, the junction voltage across gain diode chip (V_{J}) is employed as the intensity feedback signal, rather than V_{PD}. A cavity length error signal as discussed previously with reference to FIG. 3 is then derived based on the amplitude modulation and phase of V_{PD} or V_{J} in combination with modulated wavelength locking signal 422.

Controller 420 includes a digital servo loop that is configured to adjust the temperature of sled 416 such that the cavity length error signal is minimized, in accordance with the frequency modulation scheme discussed above with reference to FIGS. 2 and 3. In response to the error signal, an appropriate adjustment in temperature control signal 430 is generated. Adjustment of the sled temperature causes a corresponding change in the overall cavity length, and thus the lasing frequency. This in turn results in (ideally) a decrease in the difference between the lasing frequency and the desired channel frequency, thus completing the control loop. To reach an initial condition, or for controlling sled temperature, a resistive thermal device (RTD) 434, or a thermister or thermocouple, may be used to provide a temperature feedback signal 434 to controller 420.

When tuning a tunable laser to a target frequency (i.e., a new channel), both the tuning speed and frequency stability are very important to the operation. Embodiments of the invention provide a solution to improve both the speed and frequency stability.

As noted above, in general temperature control of the sled 416 may be used for very fine tuning adjustments of the ECDL, while coarser tuning adjustments may be made by means of tuning filter elements F1 an F2. While two filter elements are shown in FIG. 4, it is understood that more or fewer elements may be employed without departing from the scope of the invention.

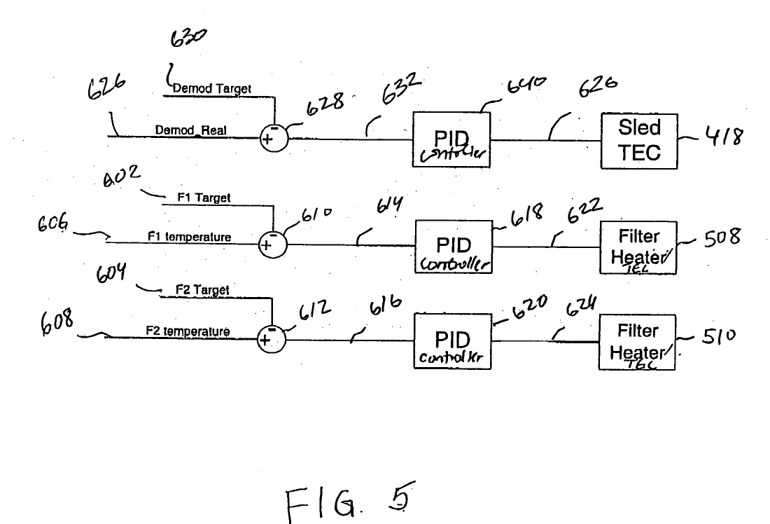

FIG. 5 shows an example control scheme for tuning the ECDL. FIG. 4 shows the controller represented by two separate blocks, however; both controller 420 and the wavelength selection control 502 including the look-up table 425 may be embodied in the same module. Referring to FIGS. 4 and 5, for a particular channel the corresponding temperatures targets 602 and 604 for the tunable filters F1 and F2 are gleaned, for example, from the look-up table 524. Signals representing the actual temperatures 606 and 608 for F1 and F2, as measured by the RDTs 512 and 514, are combined at 610 and 612 to produce error signals 614 and 616 for controlling the respective temperatures of the filter heaters or TECs 508 and 510. The error signals may be processed for example by respective PID (proportional, integral and derivative) control blocks 618 and 620, which are well known in the control system art. The PID blocks 618 and 620 produce a digital temperature command signal. The PID blocks may further include a digital/analog converter (DAC) as well as a current control circuit to control the direction of the current 624 passing through the respective TECs 508 and 510. In accordance with Peltier device principles, if a current is driven one way, the TEC functions as a heating element, while reversing the current causes the device to act as a cooling element. Thus TECs 508 and 510 can be used to adjust the temperature of the filters F1 and F2 very rapidly.

Similarly, the demodulated error signal (Demod_Real) 626 as discussed with reference to FIGS. 2 and 3 above is combined at 628 with a reference target signal 630 to produce an error signal 632 which is fed to PID controller 640. In a manner as discussed above the PID controller 640 outputs a current 626 which is used to adjust the temperature of the sled TEC 418 to vary the length of the ECDL cavity through expansion and contraction of the sled 416. Thus, the ECDL can be tuned by setting the filter temperatures F1 and F2 to select a particular channel and then use the sled temperature to lock the cavity length to match the wavelength set by the filters F1 and F2. Generally, the setting of the filter temperatures is followed by setting the sled temperature to lock the cavity and these procedures are generally accomplished independently of one another. The bandwidth of this control scheme may be limited by the signal to noise ratio on the various RDT sensors. If there are sufficient temperature disturbances to the various temperature sensors it may be difficult to provide a stiff high bandwidth control loop for the filter temperature.

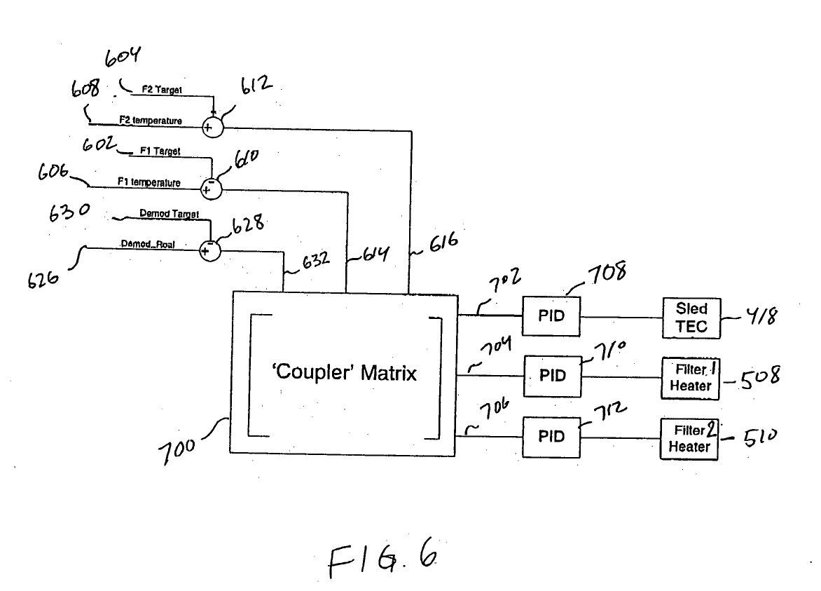

FIG. 6 shows an embodiment for a control scheme which relates the multiple input signals (614, 616 and 632) for controlling the temperatures of the Filters F1 and F2 and the sled 416 to achieve a fast and accurate lock sequence for the various components. In this case, the controller comprises a coupler matrix 700 that linearly relates the multiple input (error) signals 614, 616 and 632 to produce multiple output signals 702, 704, and 706. Each of these output signals are thereafter processed by a respective PID controller 708, 710, and 712 for controlling the temperature of the sled TEC 418, F1 TEC 508 and F2 TEC 510 as previously described.

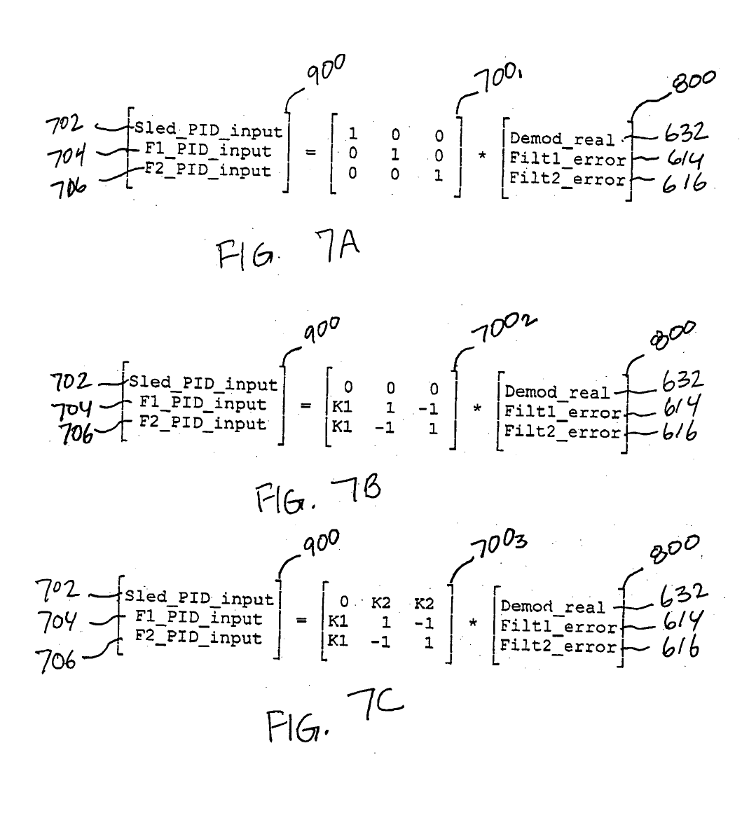

FIGS. 7A, 7B, and 7C show non-exhaustive examples of several coupler matrix configurations to achieve various results. In the example shown in FIG. 7A, the coupler matrix 700₁ is an identity matrix which when crossed with the input matrix 800 comprising the various inputs (614, 616, and 632) produces an output matrix 900 corresponding multiple output signals (704, 706, and 702) for controlling the temperatures of F1, F2, and the sled TEC, respectively. Since the identity matrix comprises numeric “1” coefficients across the diagonal, this particular configuration accomplishes the same result as the control scheme shown in FIG. 6. That is:
Sled_PID_input=(1)(Dmod_Real)+0+0
F1_PID_input=0+(1)(Filt1_error)+0
F2_PID_input=0+0+(1)Filt2_error

As shown in FIG. 7B, the coupler matrix 7002 comprises various numerical coefficients relating the signal values in the input matrix 800 to produce signals in the output matrix 900 for controlling the various PID controllers 702, 704, and 706. In this case, the K1 is a gain coefficient that may be selected to weight the filter temperature error signals more than the cavity length error signal or vice-versa. In this case, the “1s” and “−1s” in the lower right of the coupler matrix 700₂ compensates for the difference in the two filter temperatures F1 and F2. While 1 and −1 are shown in this example, other additive inverses may also be used. Further, this coupler matrix 700₂ serves to lock the filter temperature are F1 and F2 to the cavity length as:
Sled_PID_input=(0)(Dmod_Real)+(0)(Filt1_error)+(0)(Filt2_error)
F1_PID_input=(K1)(Dmod_Real)+(1)(Filt1_error)−(1)(Filt2_error)
F2_PID_input=(K1)(Dmod_Real)−(1)(Filt1_error)+(1)(Filt2_error).

As a further example, FIG. 7C shows another coupler matrix used to lock the filter temperatures F1 and F2 to the cavity length. Again, the “1s” and “−1s” in the lower right of the coupler matrix 700₃ compensates for the difference in the two filter temperatures F1 and F2. K1 and K2 are gain coefficients selected to weight the filter temperature values or the cavity length values. K1 and K2 may also be selected to include unit conversion factors since the filter error signals and the sled error signal may not be calibrated in the same units. Here, the control scheme with coupler matrix 700₃ serves to lock the filters F1 and F2 to the sled 416 rather than just commanding the sled 416 to keep the difference in the two filter temperatures constant. The control scheme of coupler matrix 7003 is set forth as:
Sled_PID_input=(0)(Dmod_Real)+(K2)(Filt1_error)+(K2)(Filt2_error)
F1_PID_input=(K1)(Dmod_Real)+(1)(Filt1_error)−(1)(Filt2_error)
F2_PID_input=(K1)(Dmod_Real)−(1)(Filt1_error)+(1)(Filt2_error).

When tuning a tunable laser to a target frequency (i.e., a new channel), both the tuning speed and frequency stability are very important to the operation. Embodiments of the invention provide a solution to improve both the speed and frequency stability.

When initially tuning the ECDL 400 to a new frequency (channel), the cavity length is on either side of the hill (P_{O}) as shown in FIG. 2 and moves to reach to the peak of the transmission curve. This may be referred to as Temperature mode where, for example, look-up tables 524 or equations may be used to set the initial filter (F1 and F2) temperatures for a given frequency. Once the desired frequency is reached the controller switches to Cavity Mode where the coupler matrix 700 control scheme may be used to accurately lock the filter temperatures to the cavity length.

While embodiments have been described in terms of locking cavity length to filter temperatures for a tunable laser, the described techniques may also be applied to other types of tunable laser that uses different types of actuators to tune to a requested frequency.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

1. A tunable laser, comprising:
a first tunable element having a corresponding first error signal;
a second tunable element having a corresponding second error signal; and
a controller to linearly relate said first error signal and said second error signal to output a first control signal to control said first tunable element and a second control signal to control said second tunable element.

2. The tunable laser as recited in claim 1 wherein said first tunable element comprises at least one temperature tunable filter and said second tunable element comprises temperature controllable cavity length.

3. The tunable laser as recited in claim 2 wherein said controller comprises:
an input matrix representation of said first and second error signals;
an output matrix representation of said first and said second control signals; and
a coupler matrix to linearly relate said input matrix to said output matrix.

4. The tunable laser as recited in claim 3 wherein said coupler matrix comprises:
an identity matrix.

5. The tunable laser as recited in claim 3 wherein said coupler matrix comprises a plurality of gain coefficients.

6. The tunable laser as recited in claim 1 wherein said first tunable element comprises a first temperature tunable filter and said second tunable element comprises a second temperature tunable filter.

7. A method for controlling a tunable laser, comprising:
representing a plurality of error signals from tunable elements as an input matrix to a controller;
representing a plurality of output signals to control said tunable elements as an output matrix;
using a coupler matrix to linearly relate said plurality of error signals in said input matrix to said output signals in said output matrix.

8. The method according to claim 7 wherein said plurality of error signals comprise at least first and second filter error signals from corresponding first and second temperature tunable filters, and a cavity length error signal.

9. The method according to claim 8 further comprising:
placing at least one gain coefficient in said coupler matrix.

10. The method according to claim 8 further comprising:
placing a plurality of additive inverse coefficients in said coupler matrix to compensate for a difference between first and second filter error signals.

11. The method according to claim 10, further comprising:
using said coupler matrix to lock temperatures of said first and second temperature tunable filters to a sled temperature for controlling cavity length.

12. The method according to claim 10, further comprising:
placing a plurality of gain coefficients in said coupler matrix for weighting said error signals in said input matrix with respect to one another.

13. The method according to claim 12 wherein said plurality of gain coefficients comprise calibration conversions.

14. The method according to claim 8 further comprising:
in a temperature mode, setting said first and second temperature tunable filters and a sled temperature for controlling cavity length to initial temperatures for a given laser frequency; and
in a cavity mode, performing said using a coupler matrix to linearly relate said plurality of error signals in said input matrix to said output signals in said output matrix.

15. The method according to claim 14, further comprising:
retrieving said initial temperatures from a look-up table.

16. An external cavity tunable laser system, comprising:
a first temperature tunable filter having a corresponding first filter error signal;
a second temperature tunable filter having a corresponding second filter error signal;
a temperature controllable sled for tuning cavity length having a corresponding cavity length error signal;
a controller comprising:
an input matrix representation of said first filter error signal, said second filter error signal, and said cavity length error signal;
an output matrix representation of control signals for said first temperature tunable filter, said second temperature tunable filter, and said temperature controllable sled; and
a coupler matrix to linearly relate said plurality of error signals in said input matrix to said output signals in said output matrix.

17. A system as recited in claim 16 further comprising:
a table to store initial temperatures for a given laser frequency.

18. The system as recited in claim 16 wherein said coupler matrix comprises:
an identity matrix.

19. The system as recited in claim 16 wherein said coupler matrix comprises:
a plurality of gain coefficients.

20. The system as recited in claim 19 wherein said coupler matrix comprises:
a plurality of additive inverse coefficients to compensate for a difference between first and second filter error signals.
